(19) United States
(12) Patent Application Publication
(10) Pub. No.: US 2011/0113022 A1
(43) Pub. Date: May 12, 2011

(54) Migration framework and related methods for devices based on profile data and associated automatic updates

(76) Inventor: Vasilis POLYCHRONIDIS, Sammamish, WA (US)

(21) Appl. No.: 12/940,712

(22) Filed: Nov. 5, 2010

Related U.S. Application Data
(60) Provisional application No. 61/258,657, filed on Nov. 6, 2009.

(51) Int. Cl. G06F 17/30; G06F 21/00

(52) U.S. Cl. 707/705; 707/802; 726/26; 707/E17.044

(57) ABSTRACT

An extensible user profile system keeping track of application settings for users from inside mobile operators and outside mobile operators. The information tracked is used to help application providers to further build enriching applications that fit the users' needs. The user profile system makes use of a network and optional local store and system to track user interaction with an application.

The current application claims a priority to the U.S. Provisional Patent application Ser. No. 61/258,657 filed on Nov. 6, 2009.

### FIELD OF INVENTION

The invention relates generally to a migration framework for devices based on profile data and associated automatic updates.

### BACKGROUND OF THE INVENTION

In the last decade Internet services started to cross boundaries and be deployed or merged with services for mobile devices. The demand for new services is forcing the mobile operators and the mobile service providers to look into how to enable rapid development for applications. Such applications would blend user experience and user data from multiple existing services and then enhance the experience by adding new features and capabilities. Each new application creates more user data and the desire is to further use these data to create even more compelling applications in the future. In the same time the desire is to give the user the option to access the same experience from multiple wireless devices and from the PC via applications or web browser. The biggest challenge an application provider faces is that the user's data-settings, preferences, personal information, identities, etc—is spread over several existing platforms and services under the control of the mobile operator or outside the control of the operator. If an application provider needs to develop an application for a device it will not have access to all these fragmented and potentially silo (vertically integrated) user data. The data would have to be available in the device or the mobile operator would have to open specific interfaces for the developers to access the user data. Therefore the application provider's choice it is only to ask the user to re-enter the data (i.e. name, address, preferences, family information etc) in order to create a compelling service.

In the same time today a user has access to multiple applications in a mobile device and this is becoming easier after the introduction of the iPhone and Android operating system. Using these applications the user generates data and preferences. This information is application specific or device specific. If the user replaces the device it will have to re-enter all the data again to get back to the level of personalization achieved with the previous device. With today's technology it is very difficult for an operator to allow the migration of the user data when the user swaps devices.

One other problem application providers need to solve is when creating an experience for a group of users; for example a family application. In this case there is a need to have access to existing data about multiple users/identities and possible relations (including access and privacy settings) between them. One application provider can possibly build an application to collect and therefore duplicate all the data in order to create the needed experience. If another application provider is looking to provide a different family application for the same users then the user will have to re-enter the same information instead using the data collected by the previous application. In the best case data is accessed via standard (open published) APIs between applications and this model has a scale issue since the connections between applications is growing at the rate of n(n−1)/2 where n is the number of applications.

Therefore it would be desirable to provide a system and method that enables the aggregation of fragmented (silo i.e. vertically integrated) user data from various data sources and applications, thus creating an extensible unified profile and the methods that enable to expose the profile data to other applications or application providers to then enable device personalization restoration and automatic application re-configuration and update. In the same time it is desirable to add methods to allow multiple devices and systems to subscribe to the profile information and to receive notifications with the latest changes in the profile thus allowing a seamless synchronization and enable the existence of the profile data to be stored at the device level. A method to allow the applications using the profile data to add more information therefore enhancing the profile data it is also desired. There is a need to create also a method to allow the creator of the unified profile to charge the application providers for accessing the profile data or portions of it in order to provide compelling user experiences. It is assumed the profile data will grow in time the more applications are being developed.

For example it is assumed such a consolidated extensible user profile will hold information such as user identities in various applications, personal information, family or other group information, applications currently used, devices used, personalization and preferences details for devices and applications, provisioning details in billing system, etc.

### BRIEF DESCRIPTION OF THE DRAWINGS

FIG. 1 shows an example system according to an embodiment of the present invention.

### DETAILED DESCRIPTIONS OF THE INVENTION

In the present invention user profiles aggregated in the User Profile System 110 and stored in a database (for example XDMS type storage) 120. The user profiles are being aggregated from existing (legacy) applications or platforms inside the mobile operator domain 140 or outside the mobile operator domain 130. Platforms that are inside the mobile operator domain 140 refer to applications and data sources that are controlled directly by a mobile operator including messaging systems, voicemail systems, home location register, billing systems, provisioning systems, or other service applications that provide applications to the end user. Platforms that are outside the mobile operator domain 130 refer to applications and data sources that are controlled by third party application providers.

The user profile is getting updated every time the user data has been changed in an associated data source. If certain user profile data that are associated with a data source is changed then the user profile system 110 will update the associated data source thus allowing the legacy application and services to continue to function as originally designed (without any synchronization issues).

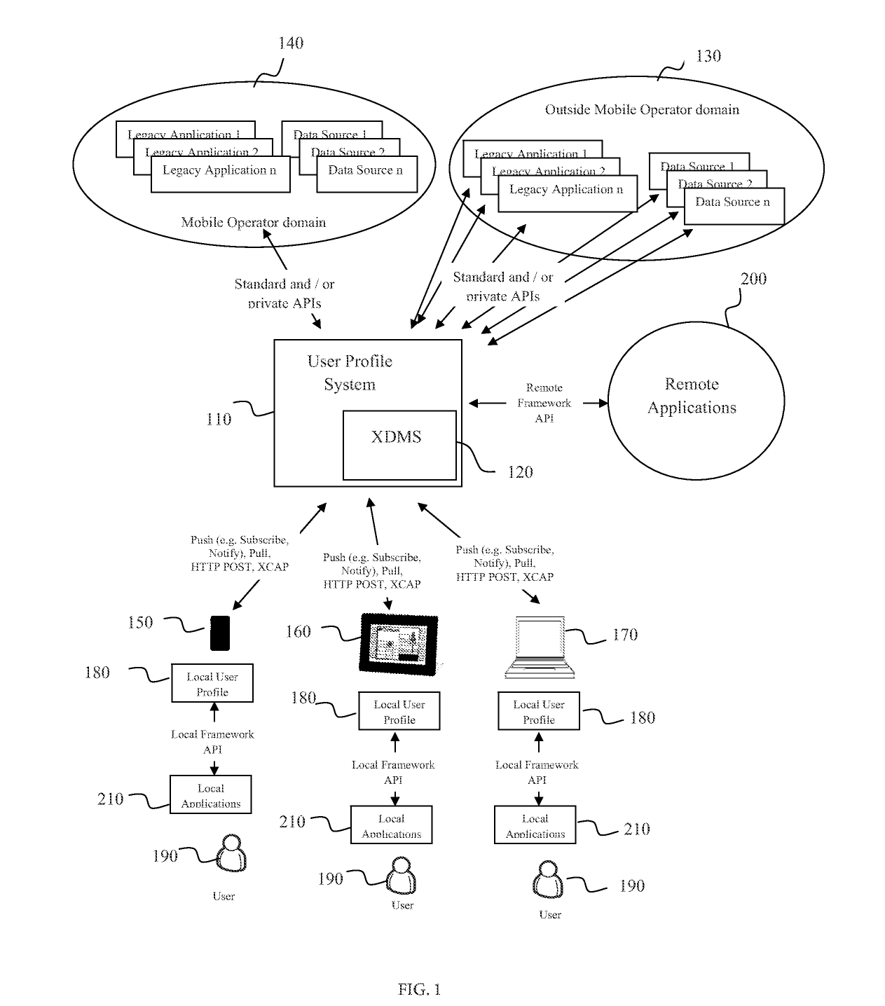

In FIG. 1 the user 190 can access the experience implemented using this invention via a plurality of devices—mobile phone 150, mobile Internet tablet 160, PC 170. In FIG. 1 the devices are mobile phones, tablet and PC but these pictures are for illustrative purposes only. These devices may be replaced by any device capable of processing, transmitting and receiving information. Any of the devices utilizing the user profile information can contribute to the profile by posting any relevant information collected about the user at the application and device level by means of the standard protocols such as HTTP or XCAP protocols.

In the invention the user profile becomes available for application providers in devices, by the implementation of a client that acts as a Local User Profile 180.

The Local User Profile client 180 connects and stays up to date with the user profile in the system 110 by the use of a push (e.g. subscribe/notify) or pull (e.g. HTTP GET) mechanism. Such a push mechanism could be SIP Subscribe/notify methods. A benefit of this invention is that a user can run the same application on multiple devices while maintaining the same user experience in each device because all the Local User Profiles are up to date with the User Profile System 110. The multiple devices are able to maintain up to date information from the user profile system 110 by means of receiving notifications of any changes. The Local User Profile gets notified by the User Profile System 110 about changes in the profile data fast and with minimal data traffic. The user profile data in the Local User Profile 180 could be updated via the notify message itself or the Local User Profile client 180 could fetch the data after receiving the notification using standard methods such as HTTP GET or XCAP GET.

The Local User Profile client 180 makes the profile data available to Local Applications 210 via a Local API Framework at the device level. The implementation of the Local User Profile 180 allows the present invention to further minimize network traffic since each Local Application 210 can fetch User Profile data from the Local User Profile 180 without the need to fetch the data from the User Profile System 110. With this method, users are able to make modifications to data on local applications and the user data will be updated and propagated to other devices, legacy applications in the inside mobile operators and the outside mobile operator domains and the remote applications for consistent usage. The modifications to the local application will automatically be transferred to the local user profile via the Local framework API. The local framework API will push this change to update the user profile system 110 via HTTP or XCAP protocols and be propagated. This enables user to have consistent and seamless experience with any device they use to access an application.

This invention can be used by a mobile operator to enable the development of rich mobile applications. The Local Profile data provides the application developers with user information (i.e. gender, family members, list of installed applications, etc.), thus the developer can build richer applications than was able before.

Another feature of the client is that it updates the user profile data in both directions. This means that an application can use the user profile data and expose that to the user via a User Interface (UI) so the user can input new information or modify existing information. The application then via the Local API Framework ingests the updated information in the Local User Profile. The Local User Profile 180 updates the User Profile System 110 via standard protocols such as HTTP POST or XCAP PUT/POST.

This allows applications to add user personalization, preferences, etc. to the profile thus enabling the provided experience to be accessible from multiple devices or migrated when the user is changing devices. Users are able to adjust the user data, preferences and customizations related to applications services that are in use or have been used in the past. An example would be when a mobile operator wants to develop a family application where the family users can access and use the application via web, mobile phone application, tablet application, Facebook application etc. As part of the family application the user needs to define who are the family members by giving names, defining roles (administrator, simple user, etc.) and performing personalization of the respective application. With this invention the application developer, has the opportunity to allow the user to first reuse some of the data that the user has already inserted in other systems before and they are now available via the User Profile system, such as in the billing system (names, phone numbers, who are the other members of the family, roles, etc.). Second the invention enables the user to configure the application by entering the initial data from one device and then enabling seamless experience from various devices via the Local User Profile updating mechanism. This initial data which are now stored in the Local User Profile can be used by current or future applications as well.

Another example is when a Local Application 210 in the device is performing personalization of the device experience. The Local Application 210 saves in the Local User Profile 180 the personalization preferences and the device information. The up to date personalization preferences and the device information are also stored in the User Profile System 110 and all associated Local User Profiles 180 in the plurality of the related devices. When the user starts using a new device the Local Application 210 in that device via the Local Framework API will use the Local User Profile data that are up to date with the data stored at User Profile System 110 to re-personalize the new device.

The present invention allows Remote Applications 200 to access the user profile data via the Remote Framework API. This allows the development of applications without access to a local user profile such as a Facebook application or other web applications. The usage data collected and aggregated in the database of the user profile system 110 is also used to help the development of application without access to the local user profile. The usage data includes relevant information collected about the users at an application device level. The relevant information collected includes the provisioned data in the billing system or other systems, present or past user data, applications settings, list of used services and applications, past or present data existent in application servers or in mobile devices, and information of past and present devices. The provisioned data in the billing system and other systems includes data used to control users' access to services consisting of price plans, data plans, monthly subscriptions, family plan information, or personal information. The user data collected as part of the usage data refers to the preferences and customizations related to application services the user is using presently or has used in the past. The application settings collected include the settings that the user provisioned for a plurality of applications. The list of used services and applications collected by the usage data include any previously deployed applications, services, or systems. The information about the devices that are collected by the usage data include the device type and device capabilities the user is currently using or used in the past. This further enhances the flexibility of the application providers on developing compelling applications and leading to a better user experience overall.

The user profile information available through the Local and Remote API framework is based on access and privacy rules associated with the information consumers. Information consumers include Local Applications 210 and Remote Applications 200. Information consumers can be segregated and classified based on their associated level of access and privacy. The application providers can be charged for using the consolidated user profile information framework with the scope of developing new rich applications. Methods of charging the application providers can be based on the level of access and privacy desired by their associated applications.

The invention implements a method to associate access and privacy rules to the profile data. The method is used to allow the user to set and be in control of the privacy and access rights to the profile data but also to allow the implementer to set and control the access and the rules to the profile data. The method and the system therefore allows local and remote applications access via the local and remote framework API to the user profiles based on the associated privacy and access rules.

The invention implements a method for charging the application providers for using the consolidated user profile information framework with the scope of enriching their associated applications capabilities. The method allows associating per application or application provider the access rules to profile data.

What is claimed is:

1. A method for migration for devices based on profile data and associated automatic updates comprises,
providing a user profile system, a plurality of devices, an inside mobile operator domain, an outside mobile operator domain, local applications, remote applications, application providers, and local user profile clients;
providing a database by the user profile system;
updating the user profile system each time user data is changed in the database;
updating associated data source related to legacy application to allow for continuous usage as originally designed
collecting of usage data for a plurality of applications or a plurality of data sources under the inside mobile operator domain and the outside mobile operator domain;
consolidating the usage data into the database of the user profile system; and
enabling the plurality of devices to contribute the usage data to the user profile system by posting through HTTP, XCAP or other similar application layer networking protocols.

2. The method as claimed in claim 1 comprises,
the plurality of devices comprises mobile phones, mobile internet tablets, PCs, or any other mobile device capable of processing, transmitting, and receiving information;
the inside mobile operator domain comprises applications, services, platforms providing messaging systems, voicemail systems, home location register, billing systems, provisioning systems, or any other service applications provided by the mobile operator;
the outside mobile operator domain comprises applications, services and platforms provided and controlled by third party application providers that are suitable for usage on mobile devices; and
the usage data comprises relevant information collected about the user at an application device level.

3. The method as claimed in claim 2 comprises,
the relevant information collected by the user profile system comprising:
a. provisioned data in the billing system or other systems used to control users' access to services consisting of price plans, data plans, monthly subscriptions information, family plan information, or personal information;
b. user data, preferences and customization related to application services the user is using or used in the past;
c. application settings that the user provisioned for the plurality of applications;
d. list of services and applications the user is using;
e. user usage data existent in application servers or in mobile devices the user is using or used in the past; and
f. information of devices that the user is currently using or has used in the past including device type and device capabilities.

4. A method as claimed in claim 1 comprises,
exposing the user profile data to the applications by means of an a Local and Remote API framework; and
minimizing network traffic by the Local and Remote API framework through utilization of persistent storage to store a copy of the user profile data into user profile system.

5. A method as claimed in claim 4 comprises,
enabling subscription to the user profile system using SIP subscription by the plurality of devices to allow receiving of notifications with any changes the user profile system with the scope to retrieve by means of HTTP or XCAP protocols the latest information about the user profile data in the user profile system; and
minimizing of network traffic by utilizing the persistent storage to store a copy of the user profile locally on the local user profile clients on the plurality of devices and the SIP subscription to update the database of the user profile system.

6. A method as claimed in claim 4 comprises,
limiting the user profile data available to the applications based on access and privacy rules associated; and
classifying and segregating the applications and associated application providers based on a level of access and privacy.

7. A method as claimed in claim 6 comprises,
charging the application providers for accessing the user profile data stored in the database of the user profile system with the scope of enriching application capabilities.

8. A method as claimed in claim 5 comprises,
updating the database of the user profile system with device and applications personalization and configurations;
retrieving of applications used in the past with other devices;
retrieving by new devices the user profile data in the new devices to be used by other applications by means of the API framework;
enhancing applications by using information gathered through accessing the user profile data about the user from previously deployed applications, services, systems or data stored; and
reducing complexity of building new applications that bridge user experiences from multiple existing applications.

9. A method for migration for devices based on profile data and associated automatic updates comprises,
providing a user profile system, a plurality of devices, an inside mobile operator domain, an outside mobile operator domain, local applications, remote applications, application providers, and local user profile clients;
providing a database by the user profile system;
updating the user profile system each time user data is changed in the database;
updating associated data source related to legacy application to allow for continuous usage as originally designed
collecting of usage data for a plurality of applications or a plurality of data sources under the inside mobile operator domain and the outside mobile operator domain;
consolidating the usage data into the database of the user profile system;
enabling the plurality of devices to contribute the usage data to the user profile system by posting through HTTP, XCAP or other similar application layer networking protocols;
exposing the user profile data to the applications by means of an a Local and Remote API framework; and
minimizing network traffic by the Local and Remote API framework through utilization of persistent storage to store a copy of the user profile data into user profile system.

10. The method as claimed in claim 9 comprises,
the plurality of devices comprises mobile phones, mobile internet tablets, PCs, or any other mobile device capable of processing, transmitting, and receiving information;
the inside mobile operator domain comprises applications, services, platforms providing messaging systems, voicemail systems, home location register, billing systems, provisioning systems, or any other service applications provided by the mobile operator;
the outside mobile operator domain comprises applications, services and platforms provided and controlled by third party application providers that are suitable for usage on mobile devices; and
the usage data comprises relevant information collected about the user at an application device level.

11. The method as claimed in claim 10 comprises,
the relevant information collected by the user profile system comprising:
a. provisioned data in the billing system or other systems used to control users' access to services consisting of price plans, data plans, monthly subscriptions information, family plan information, or personal information;
b. user data, preferences and customization related to application services the user is using or used in the past;
c. application settings that the user provisioned for the plurality of applications;
d. list of services and applications the user is using;
e. user usage data existent in application servers or in mobile devices the user is using or used in the past; and
f. information of devices that the user is currently using or has used in the past including device type and device capabilities.

12. A method as claimed in claim 9 comprises,
enabling subscription to the user profile system using SIP subscription by the plurality of devices to allow receiving of notifications with any changes the user profile system with the scope to retrieve by means of HTTP or XCAP protocols the latest information about the user profile data in the user profile system; and
minimizing of network traffic by utilizing the persistent storage to store a copy of the user profile locally on the local user profile clients on the plurality of devices and the SIP subscription to update the database of the user profile system.

13. A method as claimed in claim 9 comprises,
limiting the user profile data available to the applications based on access and privacy rules associated; and
classifying and segregating the applications and associated application providers based on a level of access and privacy.

14. A method as claimed in claim 13 comprises,
charging the application providers for accessing the user profile data stored in the database of the user profile system with the scope of enriching application capabilities.

15. A method as claimed in claim 12 comprises,
updating the database of the user profile system with device and applications personalization and configurations;
retrieving of applications used in the past with other devices;
retrieving by new devices the user profile data in the new devices to be used by other applications by means of the API framework;
enhancing applications by using information gathered through accessing the user profile data about the user from previously deployed applications, services, systems or data stored; and
reducing complexity of building new applications that bridge user experiences from multiple existing applications.

16. A method for migration for devices based on profile data and associated automatic updates comprises,
providing a user profile system, a plurality of devices, an inside mobile operator domain, an outside mobile operator domain, local applications, remote applications, application providers, and local user profile clients;
providing a database by the user profile system;
updating the user profile system each time user data is changed in the database;
updating associated data source related to legacy application to allow for continuous usage as originally designed;
collecting of usage data for a plurality of applications or a plurality of data sources under the inside mobile operator domain and the outside mobile operator domain;
consolidating the usage data into the database of the user profile system;
enabling the plurality of devices to contribute the usage data to the user profile system by posting through HTTP, XCAP or other similar application layer networking protocols;
exposing the user profile data to the applications by means of an a Local and Remote API framework;
minimizing network traffic by the Local and Remote API framework through utilization of persistent storage to store a copy of the user profile data into user profile system;
enabling subscription to the user profile system using SIP subscription by the plurality of devices to allow receiving of notifications with any changes the user profile system with the scope to retrieve by means of HTTP or XCAP protocols the latest information about the user profile data in the user profile system; and
minimizing of network traffic by utilizing the persistent storage to store a copy of the user profile locally on the local user profile clients on the plurality of devices and the SIP subscription to update the database of the user profile system.

17. The method as claimed in claim 16 comprises,
the plurality of devices comprises mobile phones, mobile internet tablets, PCs, or any other mobile device capable of processing, transmitting, and receiving information;
the inside mobile operator domain comprises applications, services, platforms providing messaging systems, voicemail systems, home location register, billing systems, provisioning systems, or any other service applications provided by the mobile operator;
the outside mobile operator domain comprises applications, services and platforms provided and controlled by third party application providers that are suitable for usage on mobile devices; and
the usage data comprises relevant information collected about the user at an application device level.

18. The method as claimed in claim 17 comprises,
the relevant information collected by the user profile system comprising:
a. provisioned data in the billing system or other systems used to control users' access to services consisting of price plans, data plans, monthly subscriptions information, family plan information, or personal information;
b. user data, preferences and customization related to application services the user is using or used in the past;
c. application settings that the user provisioned for the plurality of applications;
d. list of services and applications the user is using;
e. user usage data existent in application servers or in mobile devices the user is using or used in the past; and
f. information of devices that the user is currently using or has used in the past including device type and device capabilities.

19. A method as claimed in claim 16 comprises,
limiting the user profile data available to the applications based on access and privacy rules associated;
classifying and segregating the applications and associated application providers based on a level of access and privacy; and
charging the application providers for accessing the user profile data stored in the database of the user profile system with the scope of enriching application capabilities.

20. A method as claimed in claim 16 comprises,
updating the database of the user profile system with device and applications personalization and configurations;
retrieving of applications used in the past with other devices;
retrieving by new devices the user profile data in the new devices to be used by other applications by means of the API framework;
enhancing applications by using information gathered through accessing the user profile data about the user from previously deployed applications, services, systems or data stored; and
reducing complexity of building new applications that bridge user experiences from multiple existing applications.
